(19) United States
(12) Patent Application Publication
(10) Pub. No.: US 2007/0139983 A1
(43) Pub. Date: Jun. 21, 2007

(54) Synchronous switch reverse recovery reduction in buck converters

(75) Inventors: Brian Patrick Johnson, Cedar Park, TX (US); Daniel E. Jenkins, Bastrop, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/314,370

(22) Filed: Dec. 20, 2005

(51) Int. Cl. H02M 3/06

(52) U.S. Cl. 363/62

(57) ABSTRACT

An information handling system includes a buck converter, having a synchronous switch, to supply power to an electrical load. A first inductor is placed in series with the synchronous switch, and a second inductor is inductively coupled to the first inductor. A switched path recovers energy stored in the first inductor, via the second inductor, when the synchronous switch is open.

### BACKGROUND

The description herein relates to information handling systems and power converters for such systems.

As the value and use of information continue to increase, individuals and businesses seek additional ways to process and store information. One option available to users is information handling systems. An information handling system (“IHS”) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Most information handling systems include one or more power converters to convert power at a supply voltage (AC or DC) to power at a voltage expected by a particular electronic system component or by a group of such components.

### SUMMARY

A power converter for an information handling system includes a buck converter comprising a synchronous switch. A first inductor is inserted in series with the synchronous switch. A second inductor is inductively coupled to the first inductor. A switched path is provided to recover energy stored in the first inductor via the second inductor when the synchronous switch is open.

### BRIEF DESCRIPTION OF THE DRAWINGS

FIG. 1 is a block diagram illustrating an embodiment of an information handling system.

FIGS. 2-5 are circuit diagrams of buck power converters according to illustrative embodiments, e.g., for use in the information handling system of FIG. 1.

### DETAILED DESCRIPTION

For purposes of this disclosure, an information handling system (“IHS”) includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

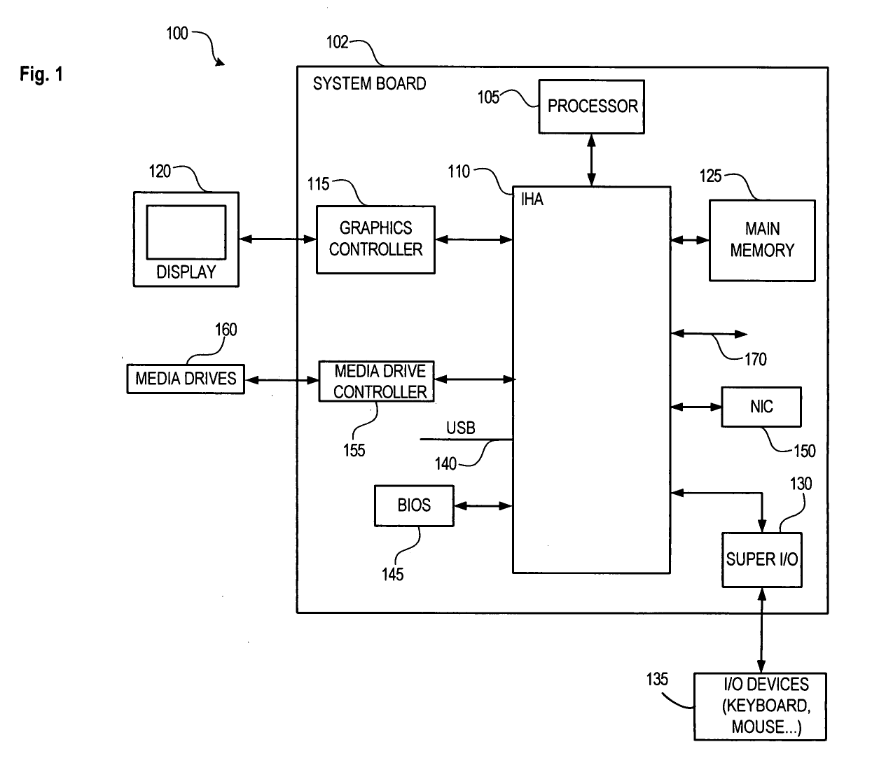

FIG. 1 is a block diagram of an information handling system (“IHS”), according to an illustrative embodiment. The IHS 100 includes a system board 102. The system board 102 includes a processor 105 such as an Intel Pentium series processor or one of many other processors currently available. An Intel Hub Architecture (IHA) chipset 110 provides the IHS system 100 with graphics/memory controller hub functions and I/O functions. More specifically, the IHA chipset 110 acts as a host controller that communicates with a graphics controller 115 coupled thereto. A display 120 is coupled to the graphics controller 115. The chipset 110 further acts as a controller for a main memory 125, which is coupled thereto. The chipset 110 also acts as an I/O controller hub (ICH) which performs I/O functions. A super input/output (I/O) controller 130 is coupled to the chipset 110 to provide communications between the chipset 110 and input devices 135 such as a mouse, keyboard, and tablet, for example. A universal serial bus (USB) 140 is coupled to the chipset 110 to facilitate the connection of peripheral devices to system 100. System basic input-output system (BIOS) 145 is coupled to the chipset 110 as shown. The BIOS 145 is stored in CMOS or FLASH memory so that it is nonvolatile.

A local area network (LAN) controller 150, alternatively called a network interface controller (NIC), is coupled to the chipset 110 to facilitate connection of the system 100 to other IHSs. Media drive controller 155 is coupled to the chipset 110 so that devices such as media drives 160 can be connected to the chipset 110 and the processor 105. Devices that can be coupled to the media drive controller 155 include CD-ROM drives, DVD drives, hard disk drives, and other fixed or removable media drives. An expansion bus 170, such as a peripheral component interconnect (PCI) bus, PCI express bus, serial advanced technology attachment (SATA) bus or other bus is coupled to the chipset 110 as shown. The expansion bus 170 includes one or more expansion slots (not shown) for receiving expansion cards which provide the IHS 100 with additional functionality.

Not all information handling systems include each of the components shown in FIG. 1, and other components not shown may exist. As can be appreciated, however, many systems are expandable, and include or can include a variety of components. Information handling systems generally provide one or more DC power sources to serve the needs of the various components at one or more supply voltages. Power sources generally comprise a power converter that accepts AC and/or DC input power at a first voltage, and supplies DC output power at a second voltage required by its load.

Power converters range in size. Large converters may supply standard voltages to bus-mounted components, drives, circuit boards, etc. Small power converters may power a single device package and be integral to that package or placed in close proximity to that package.

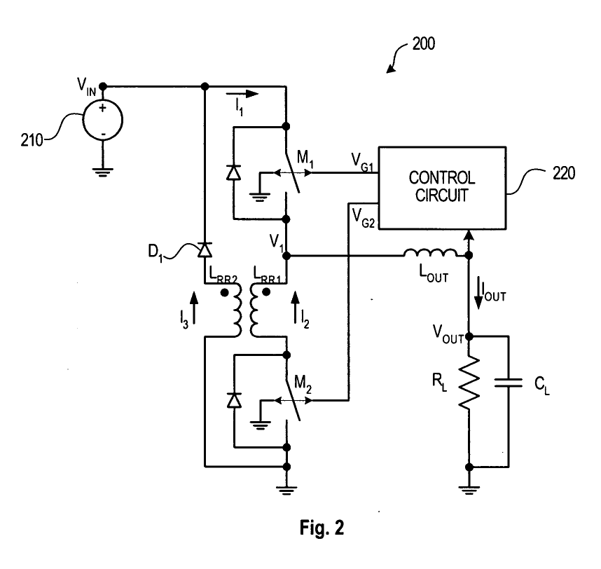

FIG. 2 illustrates a buck power converter 200 coupled between a power supply 210 and a load comprising a resistive load R_{L} and a parallel capacitance C_{L}. The power supply supplies power at a nominal voltage V_{IN}. The load requires power supplied at a component supply voltage V_{OUT}

The power converter comprises an output inductor L_{OUT}, a control MOSFET switch M₁, a synchronous MOSFET switch M₂, a control circuit 220, two coupled reverse recovery inductors L_{RR1} and L_{RR2}, and a diode rectifier D₁. Inductor L_{OUT} and switches M₁, M₂ are arranged in a buck converter configuration, with inductor L_{RR1} added to the configuration. Inductor L_{OUT} is coupled between the power converter output and a node V₁. The drain/source current path of control switch M₁ is coupled between power supply 210 and node V₁. The drain/source current path of synchronous switch M₂, in series with inductor L_{RR1}, is coupled between node V₁ and ground. The control circuit senses the voltage V_{OUT}, and supplies alternating signals to the gates of M₁ and M₂.

Inductor L_{RR2} and diode rectifier D₁ are connected in series between the power supply input V_{IN} and ground.

Control circuit 220 varies the average current I_{OUT} passing through L_{OUT}, and thereby controls V_{OUT}, by adjusting a duty cycle (the ratio of the time M₁ is on to the time period between successive M₁ activations). Control circuit 220 alternates gate signals V_{G1} and V_{G2} at a design frequency, varying the relative time each gate signal is asserted, to achieve this control. During a first portion of each cycle, gate signal V_{G1} is driven high and gate signal V_{G2} is driven low, turning on M₁ and turning off M₂. This allows node V₁ to approach V_{IN}, and a current I₁ flows from power supply 210 through M₁, and then through inductor L_{OUT} as power converter output current I_{OUT}. For the second portion of each cycle, gate signal V_{G1} is driven low and gate signal V_{G2} is driven high, turning off M₁ and turning on M₂. This allows node V₁ to approach ground potential, as a current I₂ flows from ground through M₂ and L_{RR1}, and then through inductor L_{OUT} as power converter output current I_{OUT} Note that I_{OUT} ramps upward during the first portion of each cycle, and downward during the second portion of each cycle, but cannot change instantaneously due to the inductance of L_{OUT}.

Were inductor L_{RR1} not present, several potential problems could exist. First, should the control switch M₁ be turned on while the synchronous switch M₂ is still conducting, a short circuit path from power supply 210 to ground would be momentarily present, with the potential to cause damage to the switches. Second, the reverse recovery current observed in the synchronous switch M₂ during turn-off can also damage M₁ should the reverse recovery current spike sufficiently.

In one embodiment, L_{RR1} is much smaller than L_{OUT}, and sized to protect M₁ and M₂ from brief but large transient currents at the switchover times of the converter. Should M₁ be turned on while M₂ is still conducting, L_{RR1} initially resists a rapid rate of change in current I₂, thus preventing a potentially large short-circuit current during switchover. Inductor L_{RR1} also reduces the rate of change in current I₂ during the reverse recovery time of switch M₂, thereby reducing the potential for damage to M₁ due to a high reverse recovery peak current. In one potential mode of operation, V_{G1} can thus be timed to turn on M₁ earlier with reduced potential for circuit damage.

Inductor L_{RR2} and diode rectifier D₁ recover energy from inductor L_{RR1} back to power supply 210 during the off time of synchronous switch M₂. During the on time of switch M₂, rectifier D₁ is reverse biased, blocking current I₃. As M₁ turns on and drives node V₁ to a voltage V_{IN}, and M₂ turns off, energy remains in L_{RR1} due to current I₂. Under these conditions, the voltage developed across L_{RR2} can rise high enough to forward bias D₁ momentarily, allowing L_{RR2} to remove the energy stored in L_{RR1} back to the power supply. As the energy stored in the coupled inductors is removed, D₁ once more becomes reverse biased.

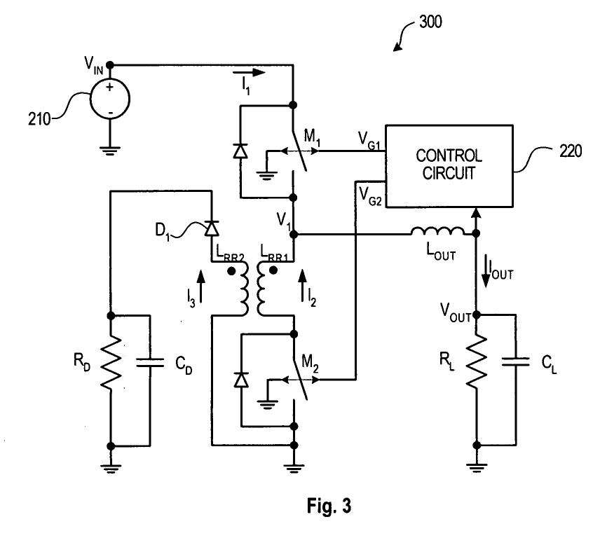

FIG. 3 shows another buck power converter 300. Instead of connecting the cathode of D₁ back to voltage V_{IN}, converter 300 connects the cathode of D₁ to a dissipation circuit comprising a resistance R_{D} and a capacitance C_{D} connected in parallel. When M₂ turns off, energy remaining in L_{RR1} can forward bias D₁, allowing L_{RR2} to remove the energy stored in L_{RR1}.

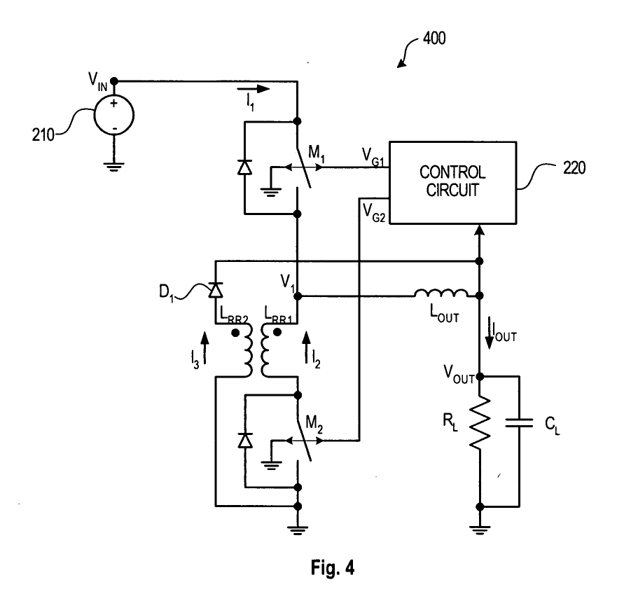

FIG. 4 shows another buck power converter 400. Instead of connecting the cathode of D₁ back to voltage V_{IN} or to a dissipation circuit, converter 400 connects the cathode of D₁ to V_{OUT}. When M₂ turns off, energy remaining in L_{RR1} can forward bias D₁, allowing L_{RR2} to remove the energy stored in L_{RR1} to the load.

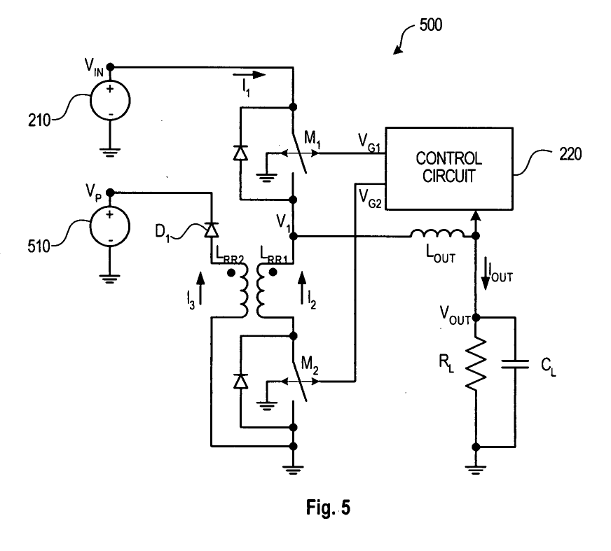

FIG. 5 shows another buck power converter 500. Instead of connecting the cathode of D₁ back to voltage V_{IN} or to a dissipation circuit or to the load, converter 500 connects the cathode of D₁ to another power supply 510 at a voltage V_{P}. When M₂ turns off, energy remaining in L_{RR1} can forward bias D₁, allowing L_{RR2} to remove the energy stored in L_{RR1} to the power supply 510. In systems using more than one power supply, power supply 510 can advantageously be selected as a power supply less sensitive to fluctuation due to size or the type of load it supports.

Those skilled in the art will recognize that a variety of circuit designs are available to implement a power converter using the teachings described herein. For instance, although a buck converter design is shown, similar principles can be applied to a boost power converter or buck/boost power converter. The synchronous switch can be a simple rectifier in some designs; in general, MOSFETs are but one example of the possible switch types.

Although illustrative embodiments have been shown and described, a wide range of other modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

1. An information handling system comprising:
an electrical load;
a buck converter, comprising a synchronous switch, to supply power to the electrical load;
a first inductor in series with the synchronous switch;
a second inductor, inductively coupled to the first inductor; and
a switched path to recover energy stored in the first inductor via the second inductor when the synchronous switch is open.

2. The information handling system of claim 1, wherein the buck converter receives input power from a power supply, the switched path allowing the recovered energy to return to the power supply.

3. The information handling system of claim 1, wherein the switched path comprises a rectifier having a forward conduction path that allows the inductor energy to return to the power supply.

4. The information handling system of claim 1, wherein the synchronous switch is a MOSFET.

5. The information handling system of claim 1, wherein the switched path recovers the energy stored in the second inductor to a load other than the power supply.

6. The information handling system of claim 1, wherein the synchronous switch is a rectifier.

7. A method of supplying power to an information handling system, the method comprising:
supplying power to one or more components of the information handling system through a switched inductor power converter having a first switched inductor that supplies load current at an output voltage, the load current supplied alternately from a voltage higher than the output voltage and from a voltage lower than the output voltage;
supplying the current supplied from the lower voltage through a series inductor;
inductively coupling a recovery inductor with the series inductor; and
activating a current path through the recovery inductor to recover energy stored in the series inductor during a time when current is supplied from the voltage higher than the output voltage.

8. The method of claim 7, wherein activating a current path through the recovery inductor comprises connecting a rectifier in series with the recovery inductor such that the rectifier is forward biased when energy remains in the coupled inductors and the load current is supplied from the voltage higher than the output voltage.

9. The method of claim 8, further comprising:
when the current path is activated, returning the recovered energy to a power supply supplying the voltage higher than the output voltage.

10. The method of claim 8, further comprising:
when the current path is activated, returning the recovered energy to a load other than the power supply supplying the voltage higher than the output voltage.

11. A power converter comprising:
a buck converter, comprising a synchronous switch;
a first inductor in series with the synchronous switch;
a second inductor, inductively coupled to the first inductor; and
a switched path to recover energy stored in the first inductor via the second inductor when the synchronous switch is open.

12. The power converter of claim 11, wherein the buck converter receives input power from a power supply, the switched path allowing the recovered energy to return to the power supply.

13. The power converter of claim 12, wherein the switched path comprises a rectifier having a forward conduction path that allows the inductor energy to return to the power supply.

14. A power converter for an information handling system, the power converter comprising:
a first inductor to supply current to a load;
a first switch to supply current to the first inductor from a power supply;
a second switch, operable to alternate with the first switch, to supply current to the first inductor from a ground path;
a second inductor interposed between the first inductor and the second switch;
a third inductor, inductively coupled to the second inductor; and
a switched path to recover energy stored in the second inductor via the third inductor when the second switch is open.

15. The power converter of claim 14, wherein the switched path, when activated, connects the third inductor to the power supply.

16. The power converter of claim 15, wherein the switched path comprises a rectifier having a forward conduction path that allows the inductor energy to return to the power supply.

17. The power converter of claim 14, wherein the first switch is a first MOSFET and the second switch is a second MOSFET, the power converter further comprising a control circuit to alternately drive the gates of the first and second MOSFETs.

18. The power converter of claim 14, wherein the switched path recovers the energy stored in the second inductor to a load other than the power supply.

19. The power converter of claim 14, wherein the second switch is a rectifier.
